(19) United States
(12) Patent Application Publication
(10) Pub. No.: US 2006/0292326 A1
(43) Pub. Date: Dec. 28, 2006

(54) Optical data store comprising a cobalt phthalocyanine with an axial substituent and axial ligand in an information photoinscribtible layer

(76) Inventors: Horst Berneth, Leverkusen (DE); Friedrich Karl Bruder, Krefeld (DE); Wilfried Haese, Odenthal (DE); Karin Hassenruck, Dusseldorf (DE); Serguei Kostromine, Swisttal (DE); Christa Maria Kruger, Schneverdingen (DE); Timo Meyer-Friedrichsen, Krefeld (DE); Josef-Walter Stawitz, Odenthal (DE); Rafael Oser, Krefeld (DE); Rainer Hagen, Leverkusen (DE)

Correspondence Address: Lanxess Corporation;Law & Intellectual Property Department, 111 Ridc Park West Drive, Pittsburgh, PA, 15275-1112, US

(21) Appl. No.: 10/534,849

(22) PCT Filed: Nov. 4, 2003
(86) PCT No.: PCT/EP03/12280

§ 371 Date: Oct. 12, 2005

(30) Foreign Application Priority Data
Nov. 15, 2002 (DE) 102536104

(51) Int. Cl. B32B 3/02

(52) U.S. Cl. 428/64.4

(57) ABSTRACT

Optical data carriers whose information layer comprises at least one light-absorbent compound which is a Co(III) phthalocyanine in which the Co metal centre bears an axial substituent R¹ and an axial coordinated ligand R², where R¹ is CN, SCN, halogen, in particular Cl, Br or F, alkoxy, aryloxy, arylthio or alkylthio and R² is no ligand or substituted or unsubstituted amine, water, an alcohol, H₂S, a thioalcohol or an isonitrile.

The present invention relates to the use of an axially substituted Co phthalocyanine as light-absorbent compound in the light-writable information layer of write-once optical data carriers, to optical data carriers and to a process for producing them.

The write-once compact disk (CD-R) has recently experienced enormous volume growth. The light-absorbent compound of the information layer of such a disk is an important component of the optical data carrier which has to meet demanding and wide-ranging requirements. The preparation of such compounds is not infrequently correspondingly demanding (cf. WO-A-02/080162).

It is therefore an object of the invention to provide further light-absorbent compounds for CD-R formats, in particular ones which are environmentally friendly and are simple to synthesize and which satisfy the high requirements (e.g. light stability, favourable signal/noise ratio, high writing sensitivity, damage-free application to the substrate material, and the like), for use as light-absorbent compound in the information layer of write-once optical data carrier (predominantly CD-R).

It has surprisingly been found that Co phthalocyanines having an axial substituent and an axial coordinated ligand are very useful for the stated purpose.

The present invention accordingly provides optical data carriers whose information layer comprises at least one light-absorbent compound which is a Co(III) phthalocyanine in which the Co metal centre bears an axial substituent R¹ and an axial coordinated ligand R², where R¹ is CN, SCN, halogen, in particular Cl, Br or F, alkoxy, aryloxy, arylthio or alkylthio and R² is no ligand or substituted or unsubstituted amine, water, an alcohol, H₂S, a thioalcohol or an isonitrile.

The optical data carrier can preferably be written on and read by means of infrared light, preferably laser light, in particular light having a wavelength in the range 750-800 nm, especially 770-790 nm.

Preference is likewise given to optical data carriers comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written and read by means of infrared light, preferably laser light, particularly preferably light having a wavelength in the range 750-800 nm, especially 770-790 nm, where the information layer comprises a light-absorbent compound and, if desired, a binder, characterized in that at least one Co(III) phthalocyanine in which the Co metal centre bears an axial substituent R¹ and an axial coordinated ligand R², where R¹ is CN, SCN, halogen, alkoxy, aryloxy, arylthio or alkylthio and R² is no ligand or NR¹⁷R¹ R¹⁹, OR¹⁰R¹¹, SR¹⁰R¹¹ or an isonitrile of the formula 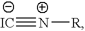
where the substituents are as defined below, is used as light-absorbent compound.

As light-absorbent compound, preference is given to using a Co phthalocyanine of the formula (I) 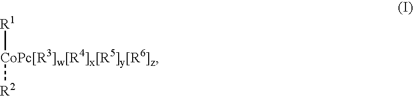
where
CoPc is cobalt(III) phthalocyanine and R¹ is an axial substituent on the cobalt and R² is an axial ligand coordinated to the cobalt and the radicals R³ to R⁶ are substituents on the phthalocyanine, where
R¹ is CN, SCN, halogen, alkoxy, aryloxy, arylthio or alkylthio, nR² is no ligand or NR¹⁷R¹⁸R¹⁹, OR¹⁰R¹¹, SR¹⁰R¹¹ or an isonitrile of the formula 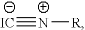
R³, R⁴, R⁵ and R⁶ are each, independently of one another, halogen, cyano, nitro, alkyl, aryl, alkylamino, dialkylamino, alkoxy, alkylthio, aryloxy, arylthio, SO₃H, SO₂NR⁷R⁸, CO₂R¹², CONR⁷R⁸, NH—COR¹² or a radical —(B)ₘ-D,
B is a bridge member selected from the group consisting of a direct bond, CH₂, CO, CH(alkyl), C(alkyl)₂, NH, S, O or —CH═CH—, where (B)ₘ is a chemically meaningful sequence of bridge members B with m=1 to 10, preferably 1, 2, 3 or 4,
D is the monovalent radical of a redox system of the formula 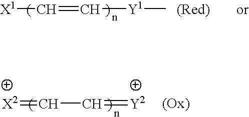
   or a metallocenyl radical or a metallocenylcarbonyl radical, with possible metal centres being titanium, manganese, iron, ruthenium or osmium,
X¹ and X² are each, independently of one another, NR′R″, OR″ or SR″,
Y¹ is NR′, O or S and Y² is NR′,
n is from 1 to 10 and
R′ and R″ are each, independently of one another, hydrogen, alkyl, cycloalkyl, aryl or hetaryl or form a direct bond or bridge to one of the carbon atoms of the 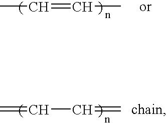
w, x, y and z are each, independently of one another, from 0 to 4, and w+x+y+z≦12,
R is alkyl or aryl,
R⁷ and R⁸ are each, independently of one another, hydrogen, alkyl, aryl or R⁷ and R⁸ together with the N atom to which they are bound form a heterocyclic 5-, 6- or 7-membered ring, if desired with participation of further heteroatoms, in particular heteroatoms selected from the group consisting of O, N and S, where NR⁷R⁸ is, in particular, pyrrolidino, piperidino or morpholino,
R¹⁰ and R¹¹ are each, independently of one another, hydrogen, alkyl, aryl or R¹⁰ and R¹¹ together with the O or S atom to which they are bound form an aromatic, pseudoaromatic, partially hydrogenated or perhydrogenated heterocyclic 5-, 6- or 7-membered ring, if desired with participation of further heteroatoms, in particular heteroatoms selected from the group consisting of O, N and S,
R¹² is alkyl, aryl, hetaryl or hydrogen,
R¹⁷, R¹⁸ and R¹⁹ are each, independently of one another, hydrogen, alkyl, aryl, hetaryl or NR¹⁷R¹⁸R¹⁹ is an aromatic, pseudoaromatic, partially hydrogenated or perhydrogenated heterocyclic 5-, 6- or 7-membered ring, if desired with participation of further heteroatoms, in particular heteroatoms selected from the group consisting of O, N und S.

The alkyl, alkoxy, aryl and heterocyclic radicals may, if desired, bear further radicals such as halogen, hydroxy, hydroxyalkyl, amino, alkylamino, dialkylamino, nitro, cyano, CO—NH₂, alkoxycarbonyl, morpholino, piperidino, pyrrolidino, trialkylsilyl or trialkylsiloxy. The alkyl and alkoxy radicals may additionally bear aryl radicals and aryl radicals may additionally bear alkyl or alkoxy radicals. The alkyl and alkoxy radicals can be saturated, unsaturated, linear or branched, the alkyl radicals may be partially halogenated or perhalogenated and the alkyl and alkoxy radicals may be ethoxylated or propoxylated or silylated. Adjacent alkyl and/or alkoxy radicals on aryl or heterocyclic radicals may together form a three- or four-membered bridge.

Preference is given to compounds of the formula (I) in which the radicals R¹ to R⁸ and R, R′, R″ and R⁹ to R¹² and R¹⁷ to R¹⁹ are:

substituents of the “alkyl” type, preferably C₁-C₁₆-alkyl, in particular C₁-C₆-alkyl, which may be substituted by halogen such as chlorine, bromine, fluorine, hydroxy, cyano and/or C₁-C₆-alkoxy;

substituents of the “alkoxy” type, preferably C₁-C₁₆-alkoxy, in particular C₁-C₆-alkoxy, which may be substituted by halogen such as chlorine, bromine, fluorine, hydroxy, cyano and/or C₁-C₆-alkyl;

substituents of the “cycloalkyl” type, preferably C₄-C₈-cycloalkyl, in particular C₅-C₆-cycloalkyl, which may be substituted by halogen such as chlorine, bromine or fluorine, hydroxy, cyano and/or C₁-C₆-alkyl.

Substituents of the “alkenyl” type, preferably C₆-C₈-alkenyl, which may be substituted by halogen such as chlorine, bromine or fluorine, hydroxy, cyano and/or C₁-C₆-alkyl, with particular preference being given to alkenyl being allyl;

substituents of the “hetaryl” type, preferably heterocyclic radicals having 5- to 7-membered rings, which preferably contain heteroatoms from the group consisting of N, S and/or O and may be fused with aromatic rings or may bear further substituents, for example halogen, hydroxy, cyano and/or alkyl, with particularly preferred heteraryl radicals being: pyridyl, furyl, thienyl, oxazolyl, thiazolyl, imidazolyl, quinolyl, benzoxazolyl, benzothiazolyl or benzimidazolyl;

substituents of the “aryl” type, preferably C₆-C₁₀-aryl, in particular phenyl or naphthyl, which may be substituted by halogen, e.g. F, Cl, hydroxy, C₁-C₆-alkyl, C₁-C₆-alkoxy, NO₂ and/or CN.

Preference is given to Co phthalocyanines of the formula (I) in which

R¹ is CN, SCN, chlorine, fluorine, bromine, iodine, alkoxy or alkylthio,

R² is no ligand or NR¹⁷R¹⁸R¹⁹, OR¹⁰R¹¹, SR¹⁰R¹¹ or an isonitrile of the formula 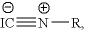
R is methyl, ethyl, propyl, isopropyl, butyl, isobutyl, tert-butyl, pentyl, tert-amyl, hydroxyethyl, 3-dimethylaminopropyl, 3-diethylaminopropyl, phenyl, p-tert-butylphenyl, p-methoxyphenyl, isopropylphenyl, trifluoromethylphenyl, benzyl or naphthyl,
R³, R⁴, R⁵ and R⁶ are each, independently of one another, chlorine, fluorine, bromine, iodine, cyano, nitro, methyl, ethyl, propyl, isopropyl, butyl, isobutyl, tert-butyl, pentyl, tert-amyl, hydroxyethyl, 3-dimethylaminopropyl, 3-diethylaminopropyl, phenyl, p-tert-butylphenyl, p-methoxyphenyl, isopropylphenyl, trifluoromethylphenyl, naphthyl, methylamino, ethylamino, propylamino, isopropylamino, butylamino, isobutylamino, tert-butylamino, pentylamino, tert-amylamino, benzylamino, methylphenylhexylamino, hydroxyethylamino, aminopropylamino, aminoethylamino, 3-dimethylaminopropylamino, 3-diethylaminopropylamino, diethylaminoethylamino, dibutylaminopropylamino, morpholinopropylamino, piperidinopropylamino, pyrrolidinopropylamino, pyrrolidonopropylamino, 3-(methylhydroxyethylamino)propylamino, methoxyethylamino, ethoxyethylamino, methoxypropylamino, ethoxypropylamino, methoxyethoxypropylamino, 3-(2-ethylhexyloxy)propylamino, isopropyloxypropylamino, dimethylamino, diethylamino, diethanolamino, dipropylamino, diisopropylamino, dibutylamino, diisobutylamino, di-tert-butylamino, dipentylamino, di-tert-amylamino, bis(2-ethylhexyl)amino, bis(aminopropyl)amino, bis(aminoethyl)amino, bis(3-dimethylaminopropyl)amino, bis(3-Diethylaminopropyl)amino, bis(diethylaminoethyl)amino, bis(dibutylaminopropyl)amino, di(morpholinopropyl)amino, di(piperidinopropyl)amino, di(pyrrolidinopropyl)amino, di(pyrrolidonopropyl)amino, bis(3-(methylhydroxyethylamino)propyl)amino, dimethoxyethylamino, diethoxyethylamino, dimethoxypropylamino, diethoxypropylamino, di(methoxyethoxyethyl)amino, di(methoxyethoxypropyl)amino, bis(3-(2-ethylhexyloxy)propyl)amino, di(isopropyloxyisopropyl)amino, methoxy, ethoxy, propyloxy, isopropyloxy, butyloxy, isobutyloxy, tert-butyloxy, pentyloxy, tert-amyloxy, 3-(2,4-dimethyl)pentoxy, methoxyethoxy, ethoxyethoxy, methoxypropyloxy, ethoxypropyloxy, methoxyethoxypropyloxy, 3-(2-ethylhexyloxy)propyloxy, methylthio, ethylthio, propylthio, isopropylthio, butylthio, isobutylthio, tert-butylthio, pentylthio, tert-amylthio, phenyl, methoxyphenyl, trifluoromethylphenyl, naphthyl, CO₂R¹², CONR⁷R⁸, NH—COR¹², SO₃H, SO₂NR⁷R⁸ or a radical of the formula 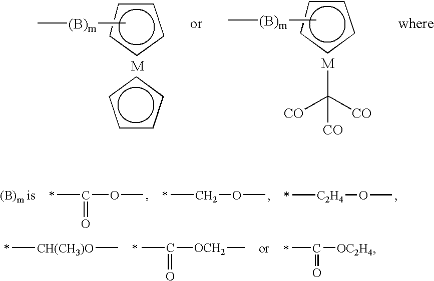
   where the asterisk (*) denotes the linkage to the 5-membered ring,
M is Mn or Fe,
w, x, y and z are each, independently of one another, from 0 to 4 and w+x+y+z≦12,
NR⁷R⁸ is amino, methylamino, ethylamino, propylamino, isopropylamino, butylamino, isobutylamino, tert-butylamino, pentylamino, tert-amylamino, benzylamino, methylphenylhexylamino, 2-ethyl-1-hexylamino, hydroxyethylamino, aminopropylamino, Aminoethylamino, 3-dimethylaminopropylamino, 3-diethylaminopropylamino, morpholinopropylamino, piperidinopropylamino, pyrrolidinopropylamino, pyrrolidonopropylamino, 3-(methylhydroxyethylamino)propylamino, methoxyethylamino, ethoxyethylamino, methoxypropylamino, ethoxypropylamino, methoxyethoxypropylamino, 3-(2-ethylhexyloxy)propylamino, isopropyloxyisopropylamino, dimethylamino, diethylamino, dipropylamino, diisopropylamino, dibutylamino, diisobutylamino, di-tert-butylamino, dipentylamino, di-tert-amylamino, bis(2-ethylhexyl)amino, dihydroxyethylamino, bis(aminopropyl)amino, bis(aminoethyl)amino, bis(3-dimethylaminopropyl)amino, bis(3-diethylaminopropyl)amino, di(morpholinopropyl)amino, di(piperidinopropyl)amino, di(pyrrolidinopropyl)amino, di(pyrrolidonopropyl)amino, bis(3-(methylhydroxyethylamino)propyl)amino, dimethoxyethylamino, diethoxyethylamino, dimethoxypropylamino, diethoxypropylamino, di(methoxyethoxypropyl)amino, bis(3-(2-ethylhexyloxy)propyl)amino, di(isopropyloxyisopropyl)amino, anilino, p-toluidino, p-tert-butylanilino, p-anisidino, isopropylanilino or naphthylamino or NR⁷R⁸ is pyrrolidino, piperidino, piperazino or morpholino,
R¹² is hydrogen, methyl, ethyl, propyl, isopropyl, butyl, isobutyl, tert-butyl, pentyl, tert-amyl, phenyl, p-tert-butylphenyl, p-methoxyphenyl, isopropylphenyl, p-trifluoromethylphenyl, cyanophenyl, naphthyl, 4-pyridinyl, 2-pyridinyl, 2-quinolinyl, 2-pyrrolyl or 2-indolyl,
NR¹⁷R¹⁸R¹⁹ is ammonia, methylamine, ethylamine, propylamine, isopropylamine, butylamine, isobutylamine, tert-butylamine, pentylamine, tert-amylamine, benzylamine, methylphenylhexylamine, 2-ethyl-1-hexylamine, hydroxyethylamine, aminopropylamine, aminoethylamine, 3-dimethylaminopropylamine, 3-diethylaminopropylamine, morpholinopropylamine, piperidinopropylamine, pyrrolidinopropylamine, pyrrolidonopropylamine, 3-(methylhydroxyethylamino)propylamine, methoxyethylamine, ethoxyethylamino, methoxypropylamine, ethoxypropylamine, methoxyethoxypropylamine, 3-(2-ethylhexyloxy)propylamine, isopropyloxyisopropylamine, dimethylamine, diethylamine, dipropylamine, diisopropylamine, dibutylamine, diisobutylamine, di-tert-butylamine, dipentylamine, di-tert-amylamine, bis(2-ethylhexyl)amine, dihydroxyethylamine, bis(aminopropyl)amine, bis(aminoethyl)amine, bis(3-dimethylaminopropyl)amine, bis(3-diethylaminopropyl)amine, di(morpholinopropyl)amine, di(piperidinopropyl)amine, di(pyrrolidinopropyl)amine, di(pyrrolidonopropyl)amine, bis(3-(methylhydroxyethylamino)propyl)amine, dimethoxyethylamine, diethoxyethylamine, dimethoxypropylamine, diethoxypropylamine, di(methoxyethoxypropyl)amine, bis(3-(2-ethylhexyloxy)propyl)amino, di(isopropyloxyisopropyl)amine, trimethylamine, triethylamine, tripropylamine, triisopropylamine, tributylamine, triisobutylamine, tri-tert-butylamine, tripentylamine, tri-tert-amylamine, tris(2-ethylhexyl)amine, trihydroxyethylamine, tris(aminopropyl)amine, tris(aminoethyl)amine, tris(3-dimethylaminopropyl)amine, tris(3-diethylaminopropyl)amine, tri(morpholinopropyl)amine, tri(piperidinopropyl)amine, tri(pyrrolidinopropyl)amine, tri(pyrrolidonopropyl)amine, tris(3-(methylhydroxyethylamino)propyl)amine, trimethoxyethylamine, triethoxyethylamine, trimethoxypropylamine, triethoxypropylamine, tri(methoxyethoxypropyl)amine, tris(3-(2-ethylhexyloxy)propyl)amine, tri(isopropyloxyisopropyl)amine, anilin, p-toluidine, p-tert-butylaniline, p-anisidine, isopropylaniline, naphthylamine, pyridine, pyridazine, pyrimidine, pyrazine, triazine, oxazine, pyrrole, pyrazole, imidazole, quinoline, pyrrolidine, piperidine, piperazine or morpholine,
OR¹⁰R¹¹ is water, methanol, ethanol, propanol, isopropanol, butanol, isobutanol, tert-butanol, pentanol, tert-amylalcohol, 3-(2,4-dimethyl)pentanol, methoxyethanol, ethoxyethanol, methoxypropanol, ethoxypropanol, methoxyethoxypropanol, 3-(2-ethylhexyloxy)propanol, diacetone alcohol, phenol, tetrahydrofuran, furan or oxazole, SR¹⁰R¹¹ is hydrogen sulphide, methyl thiol, ethyl thiol, propyl thiol, isopropyl thiol, butyl thiol, isobutyl thiol, tert-butyl thiol, pentyl thiol, tert-amyl thiol, 3-(2,4-dimethyl)pentyl thiol, methoxyethyl thiol, ethoxyethyl thiol, methoxypropyl thiol, ethoxypropyl thiol, methoxyethoxypropyl thiol, 3-(2-ethylhexyloxy)propyl thiol, diacetone thiol, thiophenol, tetrahydrothiofuran, thiofuran or oxathiazole,
   where
   the alkyl, alkoxy, aryl and heterocyclic radicals may, if desired, bear further radicals such as alkyl, halogen, hydroxy, hydroxyalkyl, amino, alkylamino, dialkylamino, nitro, cyano, CO—NH₂, alkoxy, alkoxycarbonyl, morpholino, piperidino, pyrrolidino, trialkylsilyl, trialkylsiloxy or phenyl, the alkyl and/or alkoxy radicals can be saturated, unsaturated, linear or branched, the alkyl radicals may be partially halogenated or perhalogenated, the alkyl and/or alkoxy radicals may be ethoxylated or propoxylated or silylated and adjacent alkyl and/or alkoxy radicals on aryl or heterocyclic radicals may together form a three- or four-membered bridge.

For the purposes of the present patent application, redox systems are, in particular, the redox systems described in Angew. Chem. 1978, p. 927, and in Topics of Current Chemistry, Vol. 92, p. 1 (1980).

Preference is given to p-phenylenediamine, phenothiazine, dihydrophenazine, bipyridinium salts (viologens), quinodimethane.

Preference is given to Co phthalocyanines of the formula (I) in which the sum of w, x, y and z is greater than zero, preferably from 1 to 12.

Very particular preference is given to novel compounds of the formula Ia 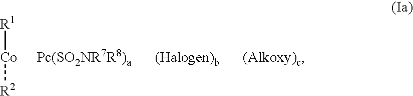
where
Halogen is chlorine, bromine or fluorine, nAlkoxy is C₁-C₈-alkoxy which may be substituted, and a is from 0 to 4, b is from 0 to 10, c is from 0 to 8, where the sum of a, b and c is ≦12 and nR¹, R², R⁷, R⁸, and CoPc are as defined above.

The invention further provides compounds of the formula (Ia) in which the respective substituents are as defined above.

The invention also provides a process for preparing compounds of the formula (Ia), which is characterized in that substituted or unsubstituted Co phthalocyanine is oxidized, subsequently reacted with KatCN, KatSCN, Kat halide, Kat alkoxide or Kat alkylthiolate and, if desired the product is reacted further with NR¹⁷R¹⁸R¹⁹, OR¹⁰R¹¹, SR¹⁰R¹¹ or an isonitrile of the formula 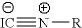
at a temperature of 30-100° C., in particular 40-70° C.,
where
R¹⁷, R¹⁸, R¹⁹, R¹⁰, R¹¹, and R are as defined above and
Kat is a lithium cation, sodium cation, potassium cation, tetrabutylammonium cation, tetrapropylammonium cation, tetraethylammonium cation, tetramethylammonium cation, triethyloxonium cation, triphenylcarbenium cation, diphenyliodonium cation, N-ethylpyridinium cation or ferrocenyl cation.

The introduction of the axial substituents is preferably carried out under oxidative conditions, e.g. chlorine or air, preferably air, in the case of air in the presence of excess KatCN, KatSCN, Kat alkoxide or Kat alkylthiolate and the optional introduction of the further axial ligands is carried out by means of NR¹⁷R¹⁸R¹⁹, OR¹⁰R¹¹, SR¹⁰R¹¹ or an isonitrile of the formula 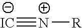
at a temperature of 20-80° C., in particular 40-60° C.

The invetion further provides mixtures containing at least 1-50% by weight, preferably more than 80% by weight, in particular more than 90% by weight, of a Co(III) phthalocyanine of the formula I having an axial substituent R¹, and an axial ligand R², where R¹ is CN, SCN, halogen, alkoxy, aryloxy, arylthio or alkylthio, and R² is no ligand or NR¹⁷R¹⁸R⁹, OR¹⁰R¹¹, SR¹⁰R¹¹ or an isonitrile of the formula

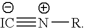

A further constituent of the mixture is preferably a phthalocyanine different from the formula I. In particular, this is a phthalocyanine of the formula II, 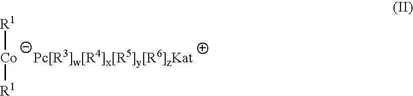
where R¹, R³, R⁴, R⁵, R⁶ w, x, y, z and CoPc are as defined above and
Kat+ is a lithium cation, sodium cation, potassium cation, tetrabutylammonium cation, tetrapropylammonium cation, tetraethylammonium cation, tetramethylammonium cation, triethyloxonium cation, triphenylcarbenium cation, diphenyliodonium cation, N-ethylpyridinium cation or ferrocenyl cation.

The mixture particularly preferably contains from 0 to 50% by weight of the dye of the formula (II), in particular from 0 to 20%, more preferably less than 10% by weight.

Particular preference is given to more than 95% by weight, in particular more than 98% by weight, of the mixture being made up of the two dyes I and II.

The light-writable information layer particularly preferably comprises, as light-absorbent compounds, a Co(III) phthalocyanine compound as described above, in particular one of the formula I, together with at least one other substituted or unsubstituted phthalocyanine with or without a central atom. Possible central atoms in this phthalocyanine are, for example, atoms from the group consisting of Si, Zn, Al, Cu, Pd, Pt, Au and Ag, in particular Cu and Pd.

The invention also provides mixtures comprising:
a) a Co(III) phthalocyanine of the formula I having an axial substituent R¹, and an axial ligand R²,
b) a phthalocyanine different from a), in particular a Co-free phthalocyanine.

The respective preferred embodiments indicated above are preferred for each of the components a) and b).

As component b), particular preference is given to, for example, the sulphonamide-substituted Cu phthalocyanines known from DE-A 19 925 712. Particular preference is given to those of the formula III 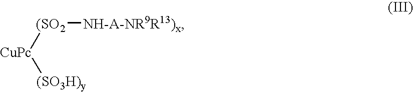
where
Cupc is a copper phthalocyanine radical,
A is a substituted or unsubstituted, straight-chain or branched C₂-C₆-alkylene such as ethylene, propylene, butylene, pentylene, hexylene,
R⁹ and R¹³ are each, independently of one another, hydrogen or substituted or unsubstituted, straight-chain or branched C₁-C₆-alkyl such as methyl, ethyl, propyl, butyl, pentyl, hexyl, in particular substituted C₁-C₆-hydroxyalkyl or unsubstituted C₁-C₆-alkyl,
   or R⁹ and R¹³ together with the N atom to which they are bound form a heterocyclic 5- or 6-membered ring which may contain a further heteroatom, e.g. S, N or O,
x is from 2.0 to 4.0,
y is from 0 to 1.5 and
   the sum of x and y is from 2.0 to 4.0, preferably from 2.5 to 4.0.

Particularly preferred mixture components c) are compounds of the formula (III) which correspond to the formula (IIIa)
CuPc—[SO₂NH—CH₂CH₂CH₂N(CH₂)₃ (IIIa),
where
CuPc is copper phthalocyanine.

Further preferred additional light-absorbent compounds are the sulphonamide- or amido-substituted phthalocyanines known, for example, from EP-A-519 395.

In the case of mixtures of various light-absorbent compounds, the proportion of the compounds of the formula (I) in the mixture is preferably from 10 to 90% by weight.

Particular preference is given to a mixture of the formulae (I) and (III) in a weight ratio of from 10:90 to 90:10, preferably from 20:80 to 80:20, particularly preferably from 40:60 to 60:40.

The information layer can comprise not only the light-absorbent compound but also binders, wetting agents, stabilizers, diluents and sensitizers and also further constituents.

The substrates can have been produced from optically transparent plastics which, if necessary, have undergone a surface treatment. Preferred plastics are polycarbonates and polyacrylates, and also polycycloolefins or polyolefins.

The reflection layer can have been produced from any metal or metal alloy which is customarily utilised for writable optical data carriers. Suitable metals and metal alloys can be applied by vapour deposition and sputtering and comprise, for example, gold, silver, copper, aluminium and their alloys with one another or with other metals.

The possible protective layer over the reflection layer can comprise UV-curing acrylates.

A possible intermediate layer which protects the reflection layer, for example against oxidation, can likewise be present.

The invention further provides a process for producing the optical data store of the invention, characterized in that a Co(III) phthalocyanine in which the Co metal centre bears an axial substituent R¹ and an axial coordinated ligand R², where R¹ is CN, SCN, halogen, in particular Cl, Br or F, alkoxy, aryloxy, arylthio or alkylthio and R² is no ligand or a substituted or unsubstituted amine, water, an alcohol, H₂S, a thioalcohol or an isonitrile, is applied as light-absorbent compound to the substrate of the optical data carrier.

Preference is given to a process for producing the optical data carrier of the invention, which is characterized in that the light-writable information layer is applied to a transparent substrate by coating with at least one Co phthalocyanine complex of the formula I, if desired in combination with other light-absorbent compounds, in particular compounds of the component b), suitable binders, additives and solvents, and, if desired, the coated substrate is additionally provided with a reflection layer, if desired further intermediate layers and if desired a protective layer.

The coating of the substrate with the light-absorbent compound of the formula I, if desired in combination with further dyes, binders and/or solvents, is preferably carried out by spin coating or sputtering.

For the coating procedure, the light-absorbent compound, in particular the compound of the formula I, is preferably dissolved with or without additives in a suitable solvent or solvent mixture so that the compound, in particular that of the formula I, is present in an amount of 100 parts by weight or less, for example from 10 to 20 parts by weight, per 100 parts by weight of solvent. The writable information layer is then preferably metallized under reduced pressure by sputtering or vapour deposition (reflection layer) and then provided, if desired, with a protective surface coating (protective layer) or a further substrate or a covering layer. Multilayer arrangements with a partially transparent reflection layer are also possible.

The solvents or solvent mixtures for the application of the light-absorbent compounds of the formula I or their mixtures with additives and/or binders and also other light-absorbent compounds are selected, firstly, according to their solvent capacity for the light-absorbent compound, in particular that of the formula I, and the other additives and, secondly, so as to have a minimal influence on the substrate. Suitable solvents which have little influence on the substrate are, for example, alcohols, ethers, hydrocarbons, halogenated hydrocarbons, alkoxy alcohols, ketones. Examples of such solvents are methanol, ethanol, propanol, 2,2,3,3-tetrafluoropropanol, butanol, in particular 1-butanol, nonanol, in particular 1-nonanol, diacetone alcohol, benzyl alcohol, tetrachloroethane, dichloromethane, diethyl ether, dipropyl ether, dibutyl ether, methyl tert-butyl ether, methoxyethanol, ethoxyethanol, 1-methyl-2-propanol, methyl ethyl ketone, 4-hydroxy-4-methyl-2-pentanone, hexane, cyclohexane, ethylcyclohexane, octane, benzene, toluene, xylene. Preferred solvents are hydrocarbons and alcohols since they have the smallest influence on the substrate. Particular preference is given to propanol, 2,2,3,3-tetrafluoropropanol, butanol and mixtures of these alcohols with diacetone alcohol or nonanol, in particular 1-nonanol, particularly preferably propanol/diacetone alcohol 80-100%/0-20%.

Suitable additives for the writable information layer are stabilizers, wetting agents, binders, diluents and sensitizers.

The light-absorbent compound should preferably be able to be changed thermally. The thermal change preferably occurs at a temperature of <600° C. Such a change can be, for example, a decomposition or chemical change of the chromophoric centre of the light-absorbent compound.

Apart from the information layer, further layers such as metal layers, dielectric layers and protective layers may be present in the optical data store. Metals and dielectric layers serve, inter alia, to adjust the reflectivity and the heat absorption/retention. Metals can be, depending on the laser wavelength, gold, silver, aluminium, etc. Examples of dielectric layers are silicon dioxide and silicon nitride. Protective layers are, for example, photocurable surface coatings, (pressure-sensitive) adhesive layers and protective films.

Pressure-sensitive adhesive layers consist mainly of acrylic adhesives. Nitto Denko DA-8320 or DA-8310, disklosed in the patent JP-A 11-273147, can, for example, be used for this purpose.

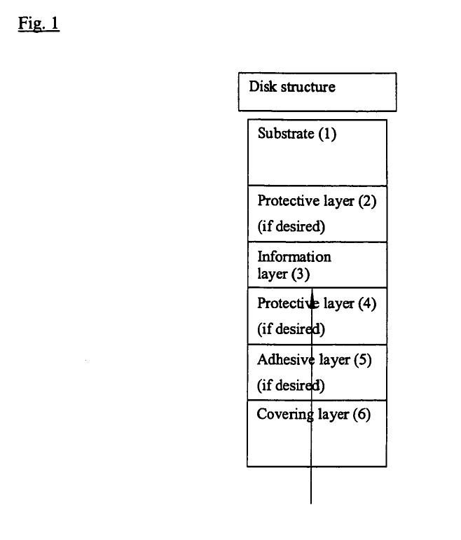

The optical data carrier has, for example, the following layer structure (cf FIG. 1): a transparent substrate (1), if desired a protective layer (2), an information layer (3), if desired a protective layer (4), if desired an adhesive layer (5), a covering layer (6).

The structure of the optical data carrier preferably:
comprises a preferably transparent substrate (1) to whose surface at least one light-writable information layer (3) which can be written on by means of light, preferably laser light, if desired a protective layer (4), if desired an adhesive layer (5) and a transparent covering layer (6) have been applied.
comprises a preferably transparent substrate (1) to whose surface a protective layer (2), at least one information layer (3) which can be written on by means of light, preferably laser light, if desired an adhesive layer (5) and a transparent covering layer (6) have been applied.
comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.
comprises a preferably transparent substrate (1) to whose surface at least one information layer (3) which can be written on by means of light, preferably laser light, if desired an adhesive layer (5) and a transparent covering layer (6) have been applied.

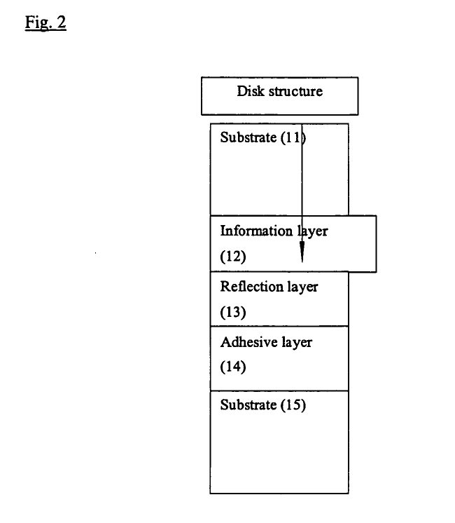

Alternatively, the optical data carrier has, for example, the following layer structure (cf. FIG. 2): a preferably transparent substrate (11), an information layer (12), if desired a reflection layer (13), if desired an adhesive layer (14), a further preferably transparent substrate (15).

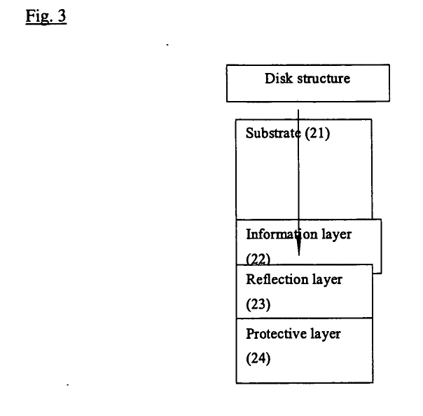

Alternatively, the optical data carrier has, for example, the following layer structure (cf. FIG. 3): a preferably transparent substrate (21), an information layer (22), if desired a reflection layer (23), a protective layer (24).

The invention further provides optical data carriers according to the invention which have been written on by means of blue, red or infrared light, in particular laser light, especially infrared laser light.

The following examples illustrate the subject matter of the invention.

### EXAMPLES

The following preparative examples demonstrate the preparation of the dyes to be used according to the invention.

### Example 1

113 g of cobalt tetra-(2,4-dimethyl-3-pentoxy)phthalocyanine (isomer mixture) are stirred overnight at room temperature (RT) with 15.63 g of KCN in 1 l of NMP. 162 g of silica gel are then added, the mixture is stirred for 1 hour and filtered with suction. The NMP solution is slowly added dropwise to a mixture of 810 g of NaCl with 2.5 l of water and ice. After stirring for 2 hours at RT, the mixture is filtered with suction and the paste is stirred in water/methanol 1:1 at 40° C. for 1 hour. After cooling, the solid is filtered off with suction and dried at 30° C. under reduced pressure. Yield: 100.6 g of dye of the formula:

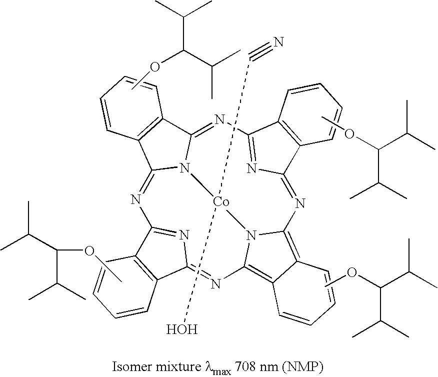

### Example 2

80 g of cobalt tetra-(2,4-dimethyl-3-pentoxy)phthalocyanine (isomer mixture) are stirred overnight at RT with 14.6 g of KCN in 800 ml of propanol while passing air through the mixture. 162 g of silica gel are then added, the mixture is stirred for another 1 hour and filtered with suction. The propanol solution is admixed with 320 ml of NMP, the propanol is distilled off and the remaining NMP solution is slowly added dropwise to a mixture of 150 g of NaCl with 1.5 l of water and ice. After stirring at RT for 1 hour, the mixture is filtered with suction and the paste is washed with 1 l of water/methanol 1:1. The paste is stirred with 1 l of water, the solid is once again filtered off with suction and dried at 40° C. under reduced pressure. Yield: 60.6 g of dye of the formula:

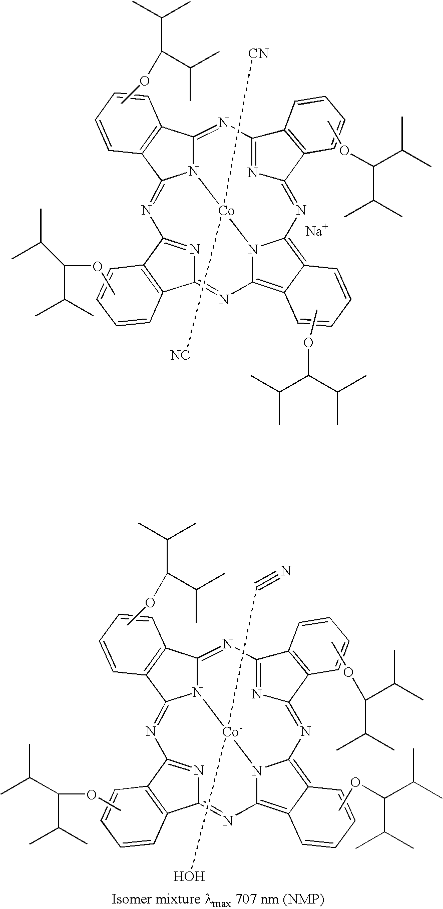

### Example 3

120 g of cobalt tetra-(2-ethylhexoxy)phthalocyanine (isomer mixture) are stirred with 15 g of KCN in 111 of NMP at RT. 162 g of silica gel are then added, the mixture is stirred for 1 hour and filtered with suction. The NMP solution is slowly added dropwise to a mixture of 6500 g of NaCl with 2 l of water and ice. After 2 hours at RT, the mixture is filtered with suction and the paste is stirred in water/methanol 1:1 at 40° C. for 1 hour. After cooling, the solid is filtered off with suction and dried at 30° C. under reduced pressure. Yield: 105 g of dye of the formula:

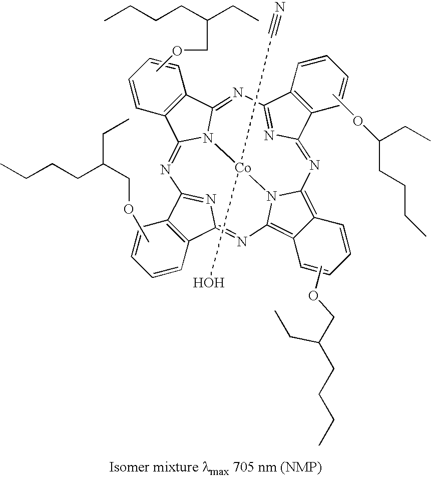

### Example 4

### Example for CD-R Dye

The dye from Example 2 was brought into solution at room temperature. The solution concentration was 20 g of dye per litre of solvent. The solvent consisted of 97% by mass of 1-propanol and 3% by mass of 1-nonanol. This solution was applied by means of spin coating to a pregrooved polycarbonate substrate. The pregrooved polycarbonate substrate had been produced as a disk by means of injection molding. The dimensions of the disk corresponded to those customarily used for CD-Rs. The groove depth and groove width were 200 nm and 730 nm, respectively. The disk with the dye layer as information carrier was coated with 100 nm of silver by vapour deposition. A UV-curable acrylic coating composition was subsequently applied by spin coating and cured by means of a UV lamp.

The finished disk was tested in a CD-R testing apparatus (Plustec OMT 2000×4) which is provided with a diode laser having a wavelength of λ=787 nm. Particularly attention was paid to the track following signal PPb and the groove reflectivity Rgb, since these two signals are critical for the disk to be accepted in a burner. The following measured values were obtained: PPb=0.089; Rgb=0.754.

### Examples 5-10

Using a method analogous to Example 4, the following disks were prepared and tested:

| | Solution | | Composition of | | |
|---|---|---|---|---|---|
| | conc. | | the solvent | | |
| Example | (g/l) | Solvent | (% by mass) | PPb | Rgb |
| 5 | 30 | 1-Butanol/ | 97/3 | 0.108 | 0.731 |
| | | 1-Nonanol | | | |
| 6 | 20 | 1-Propanol/ | 97/3 | 0.122 | 0.651 |
| | | diacetone alcohol | | | |
| 7 | 30 | 1-Butanol/ | 97/3 | 0.155 | 0.674 |
| | | diacetone alcohol | | | |
| 8 | 30 | 1-Butanol/ | 95/5 | 0.141 | 0.706 |
| | | diacetone alcohol | | | |
| 9 | 20 | 1-Propanol/ | 95/5 | 0.114 | 0.689 |
| | | diacetone alcohol | | | |
| 10 | 20 | 1-Propanol/ | 97/3 | 0.118 | 0.706 |
| | | diacetone alcohol | | | |

1. Optical data carriers whose information layer comprises at least one light-absorbent compound which is a Co(III) phthalocyanine in which the Co metal centre bears an axial substituent R¹ and an axial coordinated ligand R², where R¹ is CN, SCN, halogen, in particular Cl, Br or F, alkoxy, aryloxy, arylthio or alkylthio and R² is no ligand or substituted or unsubstituted amine, water, an alcohol, H₂S, a thioalcohol or an isonitrile.

2. Optical data carrier comprising, as light-absorbent compound, a phthalocyanine of the formula (I) 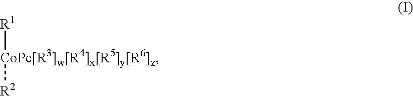
where
CoPc is cobalt(III) phthalocyanine and R¹ is an axial substituent and R² is an axially coordinated ligand and the radicals R³ to R⁶ are substituents on the phthalocyanine, where
R¹ is CN, SCN, halogen, alkoxy, aryloxy, arylthio or alkylthio,
R² is no ligand or NR¹⁷R¹⁸R¹⁹, OR¹⁰R¹¹, SR¹⁰R¹¹ or an isonitrile of the formula 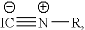
R³, R⁴, R⁵ and R⁶ are each, independently of one another, halogen, cyano, nitro, alkyl, aryl, alkylamino, dialkylamino, alkoxy, aryloxy, arylthio, alkylthio, SO₃H, SO₂NR⁷R⁸ CO₂R¹², CONR⁷R⁸, NH—COR¹² or a radical —(B)ₘ-D,
B is a bridge member selected from the group consisting of a direct bond, CH₂, CO, CH(alkyl), C(alkyl)₂, NH, S, O or —CH═CH—, where (B)ₘ is a chemically meaningful sequence of bridge members B with m=1 to 10, preferably 1,
D is the monovalent radical of a redox system of the formula 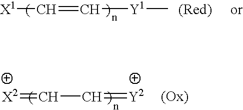
or a metallocenyl radical or a metallocenylcarbonyl radical, with possible metal centres being titanium, manganese, iron, ruthenium or osmium,
X¹ and X² are each, independently of one another, NR′R″, OR″ or SR″,
Y¹ is NR′, O or S,
Y² is NR′,
n is from 1 to 10 and
R′ and R″ are each, independently of one another, hydrogen, alkyl, cycloalkyl, aryl or hetaryl or form a direct bond or bridge to one of the carbon atoms of the 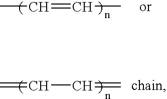
w, x, y and z are each, independently of one another, from 0 to 4, and w+x+y+z≦12,
R is alkyl or aryl,
R⁷ and R⁸ are each, independently of one another, hydrogen, alkyl, aryl or R⁷ and R⁸ together with the N atom to which they are bound form a heterocyclic 5-, 6- or 7-membered ring, if desired with participation of further heteroatoms, in particular heteroatoms selected from the group consisting of O, N and S, where NR⁷R⁸ is, in particular, pyrrolidino, piperidino or morpholino,
R¹⁰ and R¹¹ are each, independently of one another, hydrogen, alkyl, aryl or R¹⁰ and R¹¹ together with the O or S atom to which they are bound form an aromatic, pseudoaromatic, partially hydrogenated or perhydrogenated heterocyclic 5-, 6- or 7-membered ring, if desired with participation of further heteroatoms, in particular heteroatoms selected from the group consisting of O, N and S,
R¹² is alkyl, aryl, hetaryl or hydrogen,
R¹⁷, R¹⁸ and R¹⁹ are each, independently of one another, hydrogen, alkyl, aryl, hetaryl or NR¹⁷R¹⁸R¹⁹ is an aromatic, pseudoaromatic, partially hydrogenated or perhydrogenated heterocyclic 5-, 6- or 7-membered ring, if desired with participation of further heteroatoms, in particular heteroatoms selected from the group consisting of O, N und S.

3. Optical data carrier according to claim 2, characterized in that the light-writable information layer comprises at least one Co phthalocyanine of the formula I in which the radicals R¹ to R⁸ and R, R′, R″ and R¹⁰ to R¹² and R¹⁷ to R¹⁹ are:
substituents of the “alkyl” type, C₁-C₁₆-alkyl, in particular C₁-C₆-alkyl, which may be substituted by halogen such as chlorine, bromine, fluorine, hydroxy, cyano and/or C₁-C₆-alkoxy;
substituents of the “alkoxy” type, C₁-C₁₆-alkoxy, in particular C₁-C₆-alkoxy, which may be substituted by halogen such as chlorine, bromine, fluorine, hydroxy, cyano and/or C₁-C₆-alkyl;
substituents of the “cycloalkyl” type, preferably C₄-C₈-cycloalkyl, in particular C₅-C₆-cycloalkyl, which may be substituted by halogen such as chlorine, bromine or fluorine, hydroxy, cyano and/or C₁-C₆-alkyl;
substituents of the “alkenyl” type, preferably C₆-C₈-alkenyl, which may be substituted by halogen such as chlorine, bromine or fluorine, hydroxy, cyano and/or C₁-C₆-alkyl, with particular preference being given to alkenyl being allyl;
substituents of the “hetaryl” type, preferably heterocyclic radicals having 5- to 7-membered rings, which preferably contain heteroatoms from the group consisting of N, S and/or O and may be fused with aromatic rings or may bear further substituents, for example halogen, hydroxy, cyano and/or alkyl, with particularly preferred heteraryl radicals being: pyridyl, furyl, thienyl, oxazolyl, thiazolyl, imidazolyl, quinolyl, benzoxazolyl, benzothiazolyl or benzimidazolyl;
substituents of the “aryl” type, preferably C₆-C₁₀-aryl, in particular phenyl or naphthyl, which may be substituted by halogen, e.g. F, Cl, hydroxy, C₁-C₆-alkyl, C₁-C₆-alkoxy, NO₂ and/or CN.

4. Optical data carriers according to claim 1, characterized in that the Co phthalocyanine corresponds to the formula Ia 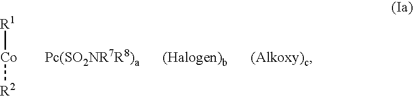
where
Halogen is chlorine, bromine or fluorine,
Alkoxy is C₁-C₈-alkoxy which may be substituted, and a is from 0 to 4, b is from 0 to 10, c is from 0 to 8, where the sum of a, b and c is ≦12 and
R¹, R², R⁷, R₈, and CoPc are as defined in claim 2.

5. Optical data carriers according to claim 2, characterized in that the light-writable information layer comprises at least one Co phthalocyanine of the formula I in which
R³, R⁴, R⁵ and R⁶ are each, independently of one another, chlorine, fluorine, bromine, iodine, cyano, methyl, ethyl, propyl, isopropyl, butyl, isobutyl, tert-butyl, pentyl, tert-amyl, hydroxyethyl, 3-dimethylamino-propyl, 3-diethylaminopropyl, phenyl, p-tert-butylphenyl, p-methoxy-phenyl, isopropylphenyl, trifluoromethylphenyl, naphthyl, methylamino, ethylamino, propylamino, isopropylamino, butylamino, isobutylamino, tert-butylamino, pentylamino, tert-amylamino, benzylamino, methylphenylhexylamino, hydroxyethylamino, aminopropylamino, aminoethylamino, 3-dimethylaminopropylamino, 3-diethylaminopropylamino, diethylaminoethylamino, dibutylaminopropylamino, morpholinopropylamino, piperidinopropylamino, pyrrolidinopropylamino, pyrrolidonopropylamino, 3-(methylhydroxyethylamino)propylamino, methoxyethylamino, ethoxyethylamino, methoxypropylamino, ethoxypropylamino, methoxyethoxypropylamino, 3-(2-ethylhexyloxy)propylamino, isopropyloxypropylamino, dimethylamino, diethylamino, diethanolamino, dipropylamino, diisopropylamino, dibutylamino, diisobutylamino, di-tert-butylamino, dipentylamino, di-tert-amylamino, bis(2-ethylhexyl)amino, bis(aminopropyl)amino, bis(aminoethyl)amino, bis(3-dimethylaminopropyl)amino, bis(3-Diethylaminopropyl)amino, bis(diethylaminoethyl)amino, bis(dibutylaminopropyl)amino, di(morpholinopropyl)amino, di(piperidinopropyl)amino, di(pyrrolidinopropyl)amino, di(pyrrolidonopropyl)amino, bis(3-(methylhydroxyethylamino)propyl)amino, dimethoxyethylamino, diethoxyethylamino, dimethoxypropylamino, diethoxypropylamino, di(methoxyethoxyethyl)amino, di(methoxyethoxypropyl)amino, bis(3-(2-ethylhexyloxy)propyl)amino, di(isopropyloxyisopropyl)amino, methoxy, ethoxy, propyloxy, isopropyloxy, butyloxy, isobutyloxy, tert-butyloxy, pentyloxy, tert-amyloxy, methoxyethoxy, ethoxyethoxy, methoxypropyloxy, ethoxypropyloxy, methoxyethoxypropyloxy, 3-(2-ethylhexyloxy)propyloxy, phenyl, methylthio, ethylthio, propylthio, isopropylthio, butylthio, isobutylthio, tert-butylthio, pentylthio, tert-amylthio, methoxyphenyl, trifluoromethylphenyl, naphthyl, CO₂R¹², CONR⁷R⁸, NH—COR¹², SO₃H, SO₂NR⁷R⁸ or a radical of the formula 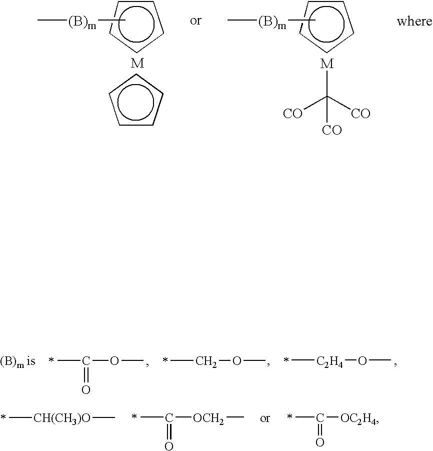
where the asterisk (*) denotes the linkage to the 5-membered ring,
w, x, y and z are each, independently of one another, from 0 to 4 and w+x+y+z≦12,
NR⁷R⁸ is amino, methylamino, ethylamino, propylamino, isopropylamino, butylamino, isobutylamino, tert-butylamino, pentylamino, tert-amylamino, benzylamino, methylphenylhexylamino, 2-ethyl-1-hexylamino, hydroxyethylamino, aminopropylamino, Aminoethylamino, 3-dimethylaminopropylamino, 3-diethyl-aminopropylamino, morpholinopropylamino, piperidinopropylamino, pyrrolidinopropylamino, pyrrolidonopropylamino, 3-(methylhydroxyethylamino)propylamino, methoxyethylamino, ethoxyethylamino, methoxypropylamino, ethoxypropylamino, methoxyethoxypropylamino, 3-(2-ethylhexyloxy)propylamino, isopropyloxyisopropylamino, dimethylamino, diethylamino, dipropylamino, diisopropylamino, dibutylamino, diisobutylamino, di-tert-butylamino, dipentylamino, di-tert-amylamino, bis(2-ethylhexyl)amino, dihydroxyethylamino, bis(aminopropyl)amino, bis(aminoethyl)amino, bis(3-dimethylaminopropyl)amino, bis(3-diethylaminopropyl)amino, di(morpholinopropyl)amino, di(piperidinopropyl)amino, di(pyrrolidinopropyl)amino, di-(pyrrolidonopropyl)amino, bis(3-(methylhydroxyethylamino)propyl)amino, dimethoxyethylamino, diethoxyethylamino, dimethoxypropylamino, diethoxypropylamino, di(methoxyethoxypropyl)amino, bis(3-(2-ethylhexyloxy)propyl)amino, di(isopropyloxyisopropyl)amino, anilino, p-toluidino, p-tert-butylanilino, p-anisidino, isopropylanilino or naphthylamino or NR⁷R⁸, in particular, is pyrrolidino, piperidino, piperazino or morpholino,
R¹² is hydrogen, methyl, ethyl, propyl, isopropyl, butyl, isobutyl, tert-butyl, pentyl, tert-amyl, phenyl, p-tert-butylphenyl, p-methoxyphenyl, isopropylphenyl, p-trifluoromethylphenyl, cyanophenyl, naphthyl, 4-pyridinyl, 2-pyridinyl, 2-quinolinyl, 2-pyrrolyl or 2-indolyl,
NR¹⁷NR¹⁸R¹⁹ is ammonia, methylamine, ethylamine, propylamine, isopropylamine, butylamine, isobutylamine, tert-butylamine, pentylamine, tert-amylamine, benzylamine, methylphenylhexylamine, 2-ethyl-1-hexylamine, hydroxyethylamine, aminopropylamine, aminoethylamine, 3-dimethylaminopropylamine, 3-diethylaminopropylamine, morpholinopropylamine, piperidinopropylamine, pyrrolidinopropylamine, pyrrolidonopropylamine, 3-(methylhydroxyethylamino)propylamine, methoxyethylamine, ethoxyethylamino, methoxypropylamine, ethoxypropyl amine, methoxyethoxypropylamine, 3-(2-ethylhexyloxy)propylamine, isopropyloxyisopropylamine, dimethyl amine, diethylamine, dipropylamine, diisopropylamine, dibutylamine, diisobutylamine, di-tert-butylamine, dipentylamine, di-tert-amylamine, bis(2-ethylhexyl)amine, dihydroxyethylamine, bis(aminopropyl)amine, bis(aminoethyl)amine, bis(3-dimethylaminopropyl)amine, bis(3-diethylaminopropyl)amine, di(morpholinopropyl)amine, di(piperidinopropyl)amine, di(pyrrolidinopropyl)amine, di-(pyrrolidonopropyl)amine, bis(3-(methylhydroxyethylamino)propyl)amine, dimethoxyethylamine, diethoxyethylamine, dimethoxypropylamine, diethoxypropylamine, di(methoxyethoxypropyl)amine, bis(3-(2-ethylhexyloxy)propyl)amino, di(isopropyloxyisopropyl)amine, trimethylamine, triethylamine, tripropylamine, triisopropylamine, tributylamine, triisobutylamine, tri-tert-butylamine, tripentylamine, tri-tert-amylamine, tris(2-ethylhexyl)amine, trihydroxyethylamine, tris(aminopropyl)amine, tris(aminoethyl)amine, tris(3-dimethylaminopropyl)amine, tris(3-diethylaminopropyl)amine, tri(morpholinopropyl)amine, tri(piperidinopropyl)amine, tri(pyrrolidinopropyl)amine, tri-(pyrrolidonopropyl)amine, tris(3-(methylhydroxyethylamino)propyl)amine, trimethoxyethylamine, triethoxyethylamine, trimethoxypropylamine, triethoxypropylamine, tri(methoxyethoxypropyl)amine, tris(3-(2-ethylhexyloxy)propyl)amine, tri(isopropyloxyisopropyl)amine, anilin, p-toluidine, p-tert-butylaniline, p-anisidine, isopropylaniline, naphthylamine, pyridine, pyridazine, pyrimidine, pyrazine, triazine, oxazine, pyrrole, pyrazole, imidazole, quinoline, pyrrolidine, piperidine, piperazine or morpholine,
OR¹⁰R¹¹ is water, methanol, ethanol, propanol, isopropanol, butanol, isobutanol, tert-butanol, pentanol, tert-amylalcohol, 3-(2,4-dimethyl)pentanol, methoxyethanol, ethoxyethanol, methoxypropanol, ethoxypropanol, methoxyethoxypropanol, 3-(2-ethylhexyloxy)propanol, diacetone alcohol, phenol, tetrahydrofuran, furan or oxazole,
SR¹⁰R¹¹ is hydrogen sulphide, methyl thiol, ethyl thiol, propyl thiol, isopropyl thiol, butyl thiol, isobutyl thiol, tert-buyl thiol, pentyl thiol, tert-amyl thiol, 3-(2,4-dimethyl)pentyl thiol, methoxyethyl thiol, ethoxyethyl thiol, methoxypropyl thiol, ethoxypropyl thiol, methoxyethoxypropyl thiol, 3-(2-ethylhexyloxy)propyl thiol, diacetone thiol, thiophenol, tetrahydrothiofuran, thiofuran or oxathiazole,
where
the alkyl, alkoxy, aryl and heterocyclic radicals may, if desired, bear further radicals such as alkyl, halogen, hydroxy, hydroxyalkyl, amino, alkylamino, dialkylamino, nitro, cyano, CO—NH₂, alkoxy, alkoxycarbonyl, morpholino, piperidino, pyrrolidino, trialkylsilyl, trialkylsiloxy or phenyl, the alkyl and/or alkoxy radicals can be saturated, unsaturated, linear or branched, the alkyl radicals may be partially halogenated or perhalogenated, the alkyl and/or alkoxy radicals may be ethoxylated or propoxylated or silylated and adjacent alkyl and/or alkoxy radicals on aryl or heterocyclic radicals may together form a three- or four-membered bridge.

6. Optical data carriers according to claim 2, characterized in that the light-writable information layer additionally contains a metal-containing or metal-free phthalocyanine which is different from (I) and in which the central atom is selected from the group consisting of: Si, Zn, Al, Cu, Pd, Pt, Au and Ag, in particular Cu or Pd.

7. Optical data carriers having an information layer which has been written on, obtainable by writing on the optical data carrier according to claim 1 by means of light having a wavelength of from 700 to 830 nm, preferably 750-800 nm.

8. Process for producing the optical data carriers as claimed in claim 1, characterized in that a Co(III) phthalocyanine in which the Co metal centre bears an axial substituent R¹ and an axial coordinated ligand R², where R¹ is CN, SCN, halogen, in particular Cl, Br or F, alkoxy, aryloxy, arylthio or alkylthio and R² is no ligand or a substituted or unsubstituted amine, water, an alcohol, H₂S, a thioalcohol or an isonitrile, is applied as light-absorbent compound to the substrate of the optical data carrier.

9. Use of Co phthalocyanines of the formula (I) as light-absorbent compounds in the light-writable information layer of optical data stores.

10. Compounds of the formula Ia 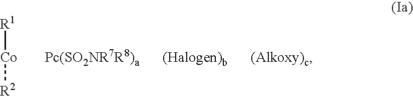
where
Halogen is chlorine, bromine or fluorine,
Alkoxy is C₁-C₈-alkoxy which may be substituted, and a is from 0 to 4, b is from 0 to 10, c is from 0 to 8, where the sum of a, band c is ≦12 and
R¹, R², R⁷, R⁸, and CoPc are as defined in claim 2.

11. Process for preparing the compound according to claim 10, characterized in that substituted or unsubstituted Co phthalocyanine of the formula (IIa)
CoPC(SO₂NR⁷R⁸)ₐ(Halogen)_{b}(Alkoxy)_{c} (IIa)
is oxidized, subsequently reacted with KatCN, KatSCN, Kat halide, Kat alkoxide or Kat alkylthiolate and, if desired the product is reacted further with NR¹⁷R¹⁸R¹⁹, OR¹⁰R¹¹, SR¹⁰R¹¹ or an isonitrile of the formula 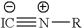
at a temperature of 30-100° C., R¹⁷, R¹⁸, R¹⁹, R¹⁰, R¹¹, and R are as defined in claim 2 and Kat is a lithium cation, sodium cation, potassium cation, tetrabutylammonium cation, tetrapropylammonium cation, tetraethylammonium cation, tetramethylammonium cation, triethyloxonium cation, triphenylcarbenium cation, diphenyliodonium cation, N-ethylpyridinium cation or ferrocenyl cation.

12. Mixtures comprising
a) a Co(III) phthalocyanine of the formula I having an axial substituent R¹, and an axial ligand R²,
c) a phthalocyanine which is different from a) and has the formula II 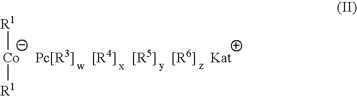
where R¹, R³, R⁴, R⁵, R⁶ w, x, y, z and CoPc are as defined in claim 2 and
Kat+ is a lithium cation, sodium cation, potassium cation, tetrabutylammonium cation, tetrapropylammonium cation, tetraethylammonium cation, tetramethylammonium cation, triethyloxonium cation, triphenylcarbenium cation, diphenyliodonium cation, N-ethylpyridinium cation or ferrocenyl cation.

13. Mixture containing at least 50% by weight of a Co(III) phthalocyanine of the formula I having an axial substituent R¹ and a coordinated ligand R², where R¹ and R² are as defined in claim 2.

14. Solutions containing dyes of the formula (I) having an axial substituent R¹ and a coordinated ligand R², where R¹ and R² are as defined in claim 2, or contain mixtures as claimed in claim 12 containing, as solvent, propanol, 2,2,3,3-tetrafluoropropanol, butanol, in particular 1-butanol, or mixtures of these with diacetone alcohol or nonanol, in particular 1-nonanol, preferably 80-100% by weight of propanol, 2,2,3,3-tetrafluoropropanol and/or butanol and 0-20% by weight of diacetone alcohol or nonanol, in each case based on the total solvent content.

15. Process according to claim 8, characterized in that the light-absorbent compound is applied in the form of a solution to the substrate by means of spin coating, where propanol, 2,2,3,3-tetrafluoropropanol, butanol, in particular 1-butanol, or mixtures of these with diacetone alcohol or nonanol, in particular 1-nonanol, preferably 80-100% by weight of propanol, 2,2,3,3-tetrafluoropropanol and/or butanol and 0-20% by weight of diacetone alcohol or nonanol, is used as solvent, with the percentages in each case being based on the total solvent content.
